(19) United States
(12) Patent Application Publication
(10) Pub. No.: US 2003/0171989 A1
(43) Pub. Date: Sep. 11, 2003

(54) Interactive on line marketing system and method therefor

(76) Inventor: Anthony Shorter, Brookvale (AU)

Correspondence Address: Thomas M Galgano, Galgano & Burke, Suite 135, 300 Rabro Drive, Hauppauge, NY, 11788, US

(21) Appl. No.: 10/312,319

(22) PCT Filed: Jun. 21, 2001
(86) PCT No.: PCT/AU01/00744

(30) Foreign Application Priority Data
Jun. 21, 2000 (AU) PQ 8221
Aug. 28, 2000 (AU) PQ 9697

(51) Int. Cl. G06F 17/60

(52) U.S. Cl. 705/14

(57) ABSTRACT

An interactive on line marketing system which allows the marketing by a supplier of products and/or services to a remote participant consumer through a supplier web site established by a host provider, wherein said remote participant consumer participates in an on line game, competition or the like via said supplier web site in return for providing an identifying consumer profile, pin number or the like to the web site of said supplier of goods and/or services; wherein the supplier of goods and services directly interacts with consumers of the providers goods and/or services or via the host.

### BACKGROUND

The present invention relates to on line interactive communications and more particularly relates to a system and method for business marketing which links one or more remote participants being target consumers with a provider of goods or services via a host web site to enable internet marketing of goods and services by the provider to said remote consumers. More particularly the system and method of the invention allows one or a plurality of remote participants namely consumers to interact with at least one remote provider via a website provided by said host thereby establishing contact between said one or a plurality of remote participants and said at least one remote provider to facilitate promotion and consumption of the remote providers goods and/or services. The interactive system allows the marketing of product information supplied by the remote provider via a website established by a host to a consumer who participates in a game, competition or the like in return for providing a consumer profile to the provider. Although the invention in all its forms will primarily be described with reference to its application to hotel marketing it will be appreciated by persons skilled in the art that the invention may be applied in a variety of industries and trading circumstances.

### PRIOR ART

There are in existence a number of on line interactive internet facilities which allow remote participants to engage in various interactive on line activities via Internet websites wherein the participant responds to data available at websites or provides participant data to a website. Examples of such systems include on line casinos and on line betting facilities available on such sports as football, motor racing and soccer. One such interactive on line gaming system provides a participant with the opportunity to choose a sport on which to wager a bet. Once a participant has joined as a member, there is ready access to such data as latest betting odds obtained from a betting database, results of events, account status and rules and regulations.

The participant enters an events web page, which provides an event selection. Once a sport is selected, the participant may then enter a bet amount following which the bet is officially placed. These systems are typified by the participant accessing an on line pre existing database, and using the data to decide how and to what extent to interact in order to allow an opportunity to gain advantage from the interaction.

There are other known Interactive real time network systems such as that described in U.S. Pat. No. 5,762,552 which teaches a network based gaming system that enables a plurality of players to place wagers on a real time game of chance conducted in a casino via a distributed network or alternatively to place wagers on a game of chance using internally generated game sequences. The systems described in this patent predominately relate to live action board games of chance, such as roulette, craps or baccarat from which the player selects the desired game. Once the game is selected the player is presented with a video representation of the possible bets on the gaming machine and a means for establishing a stake by either depositing currency or by accessing various credit accounts such as a credit card or casino credit line. A network manager transmits the results of the gaming to a remote gaming machine. The results of the gaming are transmitted to a remote gaming machine by a network manager. This system requires minimal participation by a player and the outcome as far as each player is concerned is independent of participation by all other remote participants. The system described in the above US patent does not teach participant interaction for marketing and/or participation in competitions between a remote participant and a provider via a host website established by said host for said provider of goods and/or services.

There are already in existence a variety of interactive Internet systems such as advertising systems which enable a consumer accessing the Internet to view advertising in return for payment by an advertising provider at least part of the costs of the consumers Internet time. These systems might typically involve provision by a remote participant of a consumer profile. More recently there has been an expansion of advertising on the Internet spawning interactive systems allowing a consumer to link to an advertising provider for receipt of advertisements to defray the costs of on line Internet access. The advertising is usually mixed with information and may be carried in a banner which appears on a computer screen and incidental to the main program operated by a user.

A more recent alternative form of advertising involves interaction between an advertising provider and the target consumer in which the consumer is provided with advertising which might be tailored to suit a particular consumer profile and which enables the consumer to defray Internet costs by viewing the advertisements. In these systems the consumer has some control over and choice as to when and to what extent advertising is to be viewed. In return, the consumer is able to obtain free access to the Internet commensurate with the amount of advertising viewed. One such interactive system has involved the embedding of advertising in the associated computer programs but these have the disadvantage that the advertising cannot be easily updated.

These systems have been improved to allow convenient updating of the information for the benefit of the consumer and subject of the consumer profile. As an example of the known systems, U.S. Pat. No. 5,774,869 discloses a method for promoting a sponsor's products by providing a consumer with sponsor paid access to the Internet. The method described utilises Internet access software which has a unique PIN number for each consumer computer. An Internet Entry Server verifies the PIN number and times the sponsor paid Internet access. In return, the Internet Entry Server performs a registration process which includes personal questions about the consumer whereupon the sponsor gathers queries for response by the user and gives the user a guided tour of the sponsor's Internet page where the user is exposed to current products and services of the sponsor. The user is then free to browse the Internet and after the free time is over, user paid refresh options are available. One disadvantage of this system is that the user is prevented from Internet browsing during the guided tour and is thus totally subservient to the sponsor for the period of the tour. A disadvantage of this system is that the advertising service is incidental to the primary purpose of the remote participant namely Internet so that the participant is only interested in the promotional advertising for saving money rather than interacting with the advertiser. Another disadvantage of the known advertising systems is that the advertising provider does not interact directly with the remote participant who is the advertising consumer for the purpose of selling the advertisers products.

U.S. Pat. No. 5,446,919 discloses a communication system and method with demographically or psycho graphically defined audiences. This system employs a database which contains information about audience members and selects the most appropriate media message for that audience.

U.S. Pat. No. 5,740,549 discloses an advertising distribution system including a database which stores data which can be updated. The database contains categorised advertisements. An information administrator in each work station establishes communication with the data server from time to time so as to update the information items and advertisements stored in local memory with at least a subset of the information items stored in the data server. The system further includes a subset of workstations including a profiler for storing data representing subscriber information and viewing preferences indicating categories for which the subscriber does and does not want to view information items. The user can select advertising information at will and the system will detect idleness criteria wherein the user fails to input for a predetermined amount of time. The object of the invention in that patent is to disseminate information and advertisements to subscribers' computers where the advertising and information is automatically displayed when the user's computer is on but meets predetermined idleness criteria. The invention described in U.S. Pat. No. 5,740,549 was an attempt to mix advertising and information supply over the Internet in a manner which is acceptable to users and advertisers. The system is specifically intended to disseminate information during time periods when the user's computer is inactive. U.S. Pat. No. 5,933,811 discloses a system and method for delivering customised advertising within the framework of an interactive communication system wherein an Internet consumer may have an Internet account credited each time the consumer views a custom advertisement. The system described in this patent relies on direct interaction between the service provider, the consumer and the advertising provider via the consumer's computer. The system operation is partially controlled at the consumer end which relies on the control module to determine interaction with the advertisement provider. Embedded advertisement requests in the consumer's computer direct the consumer computer to invoke the referenced content provider script and obtains the content provider member code.

Each content provider creates a program called a content provider script and transfers an advertising request to the content provider which identifies the content provider script. The advertising request contains commands which invoke the content provider script. This system is relatively complex and is totally reliant on the efficacy of the enabling software.

Another known interactive Internet advertising system uses an advertisement serving engine which facilitates consumer access to advertisements in return for payment of a percentage of Internet on-line costs. That system allows the consumer to view advertising whilst browsing the world wide web, working on a document or sending Email. This system does not provide direct communication between the advertiser and consumer nor is the supplier of the advertised goods or services in direct contact with the remote consumer. In facts the only incentive provided to the consumer is free Internet access and not benefits from interaction with the supplier of the advertised goods and/or services.

Although the above described Internet based systems are interactive, allow for the participation of

an unlimited number of remote participants, allow an exchange of information and data for achieving the principal objective of the system, they do not provide or teach an interactive system and method for directly engaging a consumer of supplier's goods or services by providing benefits in engaging the supplier directly. The system allows an unlimited number of remote participants to access a host website provider and/or to interact with a potentially unlimited number of websites belonging to goods and/or service suppliers providers.

### INVENTION

The present invention seeks to provide an interactive system which allows the marketing of products and services information supplied by a remote provider via a website established by a host to a consumer who participates in a game, competition or the like in return for providing a consumer profile to the provider of goods and/or services; wherein the provider of goods and services directly interacts with consumers of the providers goods and/or services via the host. The system allows an unlimited number of remote participants to access a host web site provider and/or to interact with a potentially unlimited number of websites belonging to goods and/or service suppliers. The present invention further provides an interactive marketing system for conducting marketing on-line between an unlimited number of remote participants and an unlimited number of remote goods and/or service providers via a host which facilitates access between said remote participants and said remote goods and service providers; wherein each participant may gain access to said host and to a number of web sites associated with said goods and service providers.

More particularly, the invention provides a marketing system for a potentially unlimited number of remote consumers wherein the remote participants communicate with other remote suppliers of goods and/or services participants wherein the other remote suppliers include retailers, wholesalers, hoteliers and the like and wherein there is provided a host provider through which said remote participants communicate with said remote suppliers providers.

In one broad form the present invention comprises:

an interactive Internet marketing system for marketing goods and/or services of a supplier to consumers according to a consumer profile wherein a potentially unlimited number of remote participants are directed to a potentially unlimited number of goods and/or service suppliers via a host/provider website: wherein the system further comprises a host website having a potentially unlimited number of web pages and at least one remote participant consumer who connects to said website; wherein said host website includes at least one web page for at least one goods and/or services supplier; wherein said remote goods and services suppliers provide an incentive for each said remote participants to access a website of said at least one provider via said host website.

Preferably the remote participants provide a consumer parameter which may be a profile to said goods and/or service supplier providers thereby establishing a marketing link between said remote consumer and said suppliers.

In another broad form the present invention comprises:

an interactive Internet marketing system for marketing goods and/or services of a supplier to consumers according to an identifying consumer parameter wherein a potentially unlimited number of remote participants are directed to a potentially unlimited number of goods and/or services suppliers via a host website: wherein the system further comprises a host/provider web site having a potentially unlimited number of web pages and at least one remote participant consumer who connects to said website responsive to an invitation; wherein said host web site includes at least one web page for at least one goods and/or services supplier; wherein said remote goods and service suppliers provide an incentive for each said remote participants to access a website of said at least one supplier via said host website; wherein said remote participants gain entry to the marketing system by one or more events, selected from, receiving a complimentary token, draw card or the like direct from the premises of the goods and/or services supplier, receiving a complimentary draw card from the goods and/or services supplier via direct mail out to said remote participant.

Preferably, the draw card includes one or more of a token, an answer to a question, or a PIN number. According to a preferred embodiment, the token or card may be given away at the premises of the goods and/or services provider or may be mailed to prospective customers. The PIN number will be a lucky number unique to each card.

In its broadest form the present invention comprises;

an interactive on-line marketing system which allows the marketing by a supplier of products and/or services to a remote participant consumer through a supplier website established by a host provider, wherein said remote participant consumer participates in an on line game, competition or the like via said supplier website in return for providing an identifying consumer profile, pin number or the like to the website of said supplier of goods and/or services; wherein the supplier of goods and services directly interacts with consumers of the providers goods and/or services or via the host.

In another broad form the present invention comprises;

an interactive marketing system for conducting marketing of goods and/or services on line between a potentially unlimited number of remote consumer participants and an unlimited number of remote goods and/or service suppliers via a host which facilitates access between said remote participants and said remote goods and service suppliers; wherein each remote participant may gain access to said host provider and to one or more websites associated with said goods and service suppliers, thereby gaining eligibility to play in a game, competition or the like in return for providing an identifying consumer profile, pin number or the like.

In another broad form the present invention comprises;

an interactive internet marketing system for marketing goods and/or services of at least one supplier to remote participant consumers identified according to a consumer profile or PIN number; wherein a potentially unlimited number of said remote participant consumers are directed to a website of a potentially unlimited number of goods and/or service suppliers; wherein, the system further comprises a host website allowing access to a potentially unlimited number of web pages by said at least one remote participant consumer who connects to said web site; wherein said remote goods and service suppliers provide an incentive for each said remote participants to access a web page of said at least one supplier; wherein said remote participants gain entry to the marketing system by one or more events, selected from, receiving a complimentary token, draw card or the like direct from the premises of the goods and/or services provider, receiving a complimentary draw card from the goods and/or services provider via direct mail out to said remote participant.

According to the method aspect the present invention comprises:

an interactive on line marketing method in which a potentially unlimited number of remote participants are directed directly or via a host website to a website of a potentially unlimited number of goods and/or service providers: wherein the method comprises the steps of;

a) establishing a host website;

b) allowing at least one remote participant consumer to connect to said host website;

c) providing at said website links to at least one web page for at least one goods and/or services supplier;

d) inviting each said consumers to provide an identifying parameter such as a PIN number consumer profile or the like;

e) allowing each consumer to participate in an on line game, competition or the like via said supplier website in return for providing an identifying consumer profile, pin number or the like to the website of said supplier of goods and/or services.

Preferably, the method comprises the further steps; of direct mailing said remote participants or handing to remote participants a token, number, card or the like having a unique identifier for each remote participant enabling each said remote participant to participate in a competition via a website of each goods and/or services provider. The remote participant interacts with the website provided by the host on behalf of the goods and services provider. The first stage of the website interaction involves the completion of a number of questions which might relate to the remote participants consumer profile. According to one embodiment the participant will then be taken to a question and answer submit page in which the remote participant will answer a number of questions which will establish a profile in the website data base about the remote participant.

In return for the remote participant submitting to questions about the participant's profile the web site owner will allow the remote participant to participate in the system and at the same time develops a data base on each one of the remote participants.

In an alternative form of the method aspect the present invention comprises:

a method for providing interactive on line marketing system in which a potentially unlimited number of remote participants are directed to a potentially unlimited number of goods and/or service suppliers via a host web site: wherein the method comprises the steps of;

a) establishing a host/provider website having or having links to a potentially unlimited number of web pages for a potentially unlimited number of goods and services suppliers;

b) allowing at least one remote participant consumer to connect to said host website;

c) providing an incentive for each said remote participants to access a website of said at least one supplier either direct or via said host website;

d) initially engaging a remote participant by providing at the premises of a goods and services supplier, via mail, via telecommunications or via the internet to said remote participant, a complimentary draw card, token or the like from which the remote participant obtains a key to enter the marketing system; wherein said key may be selected from a PIN number which will be unique to each remote participant, a phrase, word or the like;

e) allowing each said remote participant to enter a website of a participating goods and/or services supplier;

f) inviting said remote participant to submit to a questionnaire to establish a profile of said participant;

g) inviting said remote participant to visit the goods and services suppliers premises to gain promotional advantages.

In another broad form of the method aspect the present invention comprises:

a method for on line marketing in a predetermined field of endeavor the method involving participation by at least one of a potentially unlimited number of remote participant consumers wherein said host web site includes web pages of a potentially unlimited number of providers of goods and services; wherein the providers of goods and services offer an incentive to said remote participants to engage a web page of the provider via said host website; wherein the provider pays the host for establishment of the provider website.

### DETAILED DESCRIPTION

The present invention will now be described in more detail according to a preferred but non limiting embodiment and with reference to the accompanying illustrations; wherein;

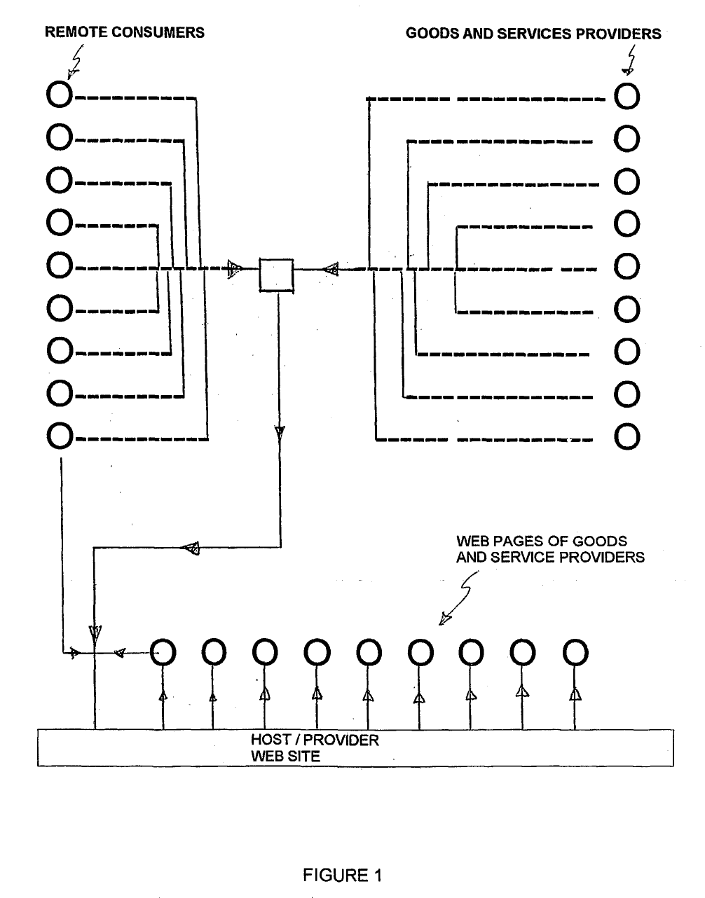

FIG. 1 shows a schematic layout of a network according to a preferred embodiment of the invention.

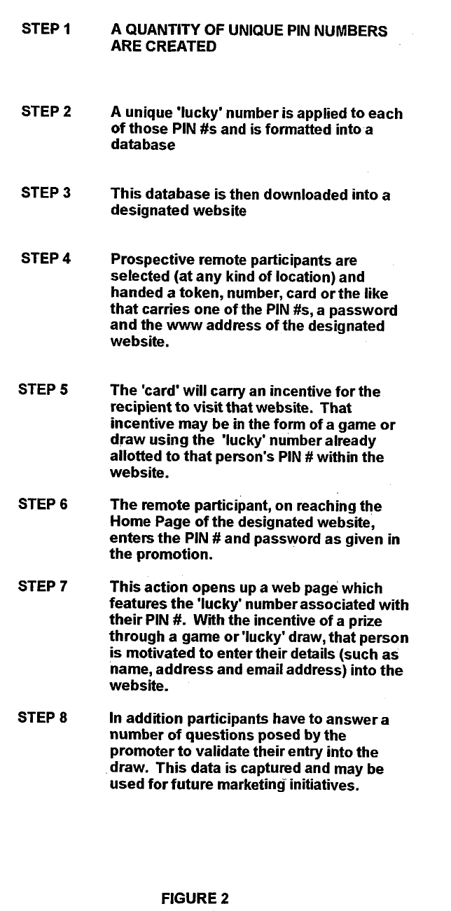

FIG. 2 shows a schematic layout of a method steps of interaction between a consumer and a goods and/or services supplier according to one embodiment.

Although the present invention may be applied to a variety of fields of trade it will predominately be described with reference to its application to hotel industry. The present invention was conceived in response to recognition that traders will be reluctant to sponsor their own websites where there is little or no financial return to justify the expense in maintaining the site. Traders expect profit and advantage from web sites without which they see little point in maintaining a site and the set up costs. Traders need to know who is going to visit the website and where the profit if any, will come from. Also traders would prefer not to have the responsibility of setting up and maintaining the site.

The present invention recognises the benefits of a low cost website and makes the concept of a web site attractive to traders by opening up wide consumer markets.

The concept provides a means to keep existing customers informed of the facilities provided by a trader, to increase the frequency of visits by casual consumers, and to attract new patrons and attract new internet surfers to the trader's site.

According to a preferred embodiment, a website is set up by a host who provides a contact site for remote consumers. The host site also provides a website for each of an unlimited number of remote goods and/or service suppliers for which a fee is charged by the host. The host manages websites and updates each site as the need arises and this relieves the burden on the provider of goods and services of the high cost of establishment and maintenance of the website.

In a typical example, a hotel proprietor will commission the host to prepare a website tailored to suit the services provided by the hotelier. The hotelier will offer incentives to its existing or new patrons to visit the website of the hotel. For the cost of the website the hotelier will gain access to a wider market which offsets the costs of the website. Remote consumers will be given rewards such as prizes to participate in schemes offered by the hotelier. The Remote consumers will gain access to services offered by the hotelier and will be attracted to the hotelier's web page thereby attracting business to the hotelier.

As an example of incentives which may be offered to each remote participant is a periodic draw for cash and/or beverages. To enter the draw the remote consumer must visit the hotel to obtain a “key” into the competition. This might for example be a phrase of the month which the patron might obtain from table talkers, coasters or beer mats. The remote participant consumer enters the competition by inserting the key which might be a number, word, phrase, phrase of the month into the hotel web site either directly or via a host website.

As part consideration for entering the competition, the consumer is asked a number of questions for instance about the services provided by the hotel. In submitting the details of the consumer, the hotel will be provided with such data as the consumer's Email address. This enables the hotelier to build a consumer profile for future marketing.

The above example may be applied to a wide variety of trade and marketing activities.

Also the host website provides cheaper access for the owner of each web site to new markets and reduced administration costs.

FIG. 2 shows a schematic of a number of steps involved in an example of the operation of the system according to a preferred embodiment. Preferably, the first step is to create a quantity of unique numbers, following which, a unique ‘lucky’ number is applied to each of those PIN numbers and is formatted into a database. The database is then downloaded into a designated website. Prospective remote participants are randomly selected (at any kind of location) and handed a token, number, card or the like that carries one of the PIN numbers, a password and the www address of the designated website. The ‘card’ will carry an incentive for the recipient to visit that website. That incentive may be in the form of participation in a game or draw using the ‘lucky’ number already allocated to that person's PIN number within the website. The remote participant, on reaching the Home Page of the designated website, enters the PIN number and password as given in the promotion. This step opens up a web page which features the ‘lucky’ number associated with their PIN number. With the incentive of a prize through a game or ‘lucky’ draw, that person is motivated to enter their details (such as name, address and email address) into the website. Preferably, in addition participants have to answer a number of questions posed by the promoter to validate their entry into the draw. This data is captured and may be used for future marketing initiatives.

It will be recognised by persons skilled in the art that numerous variations and modifications may be made to the invention as broadly described herein without departing from the overall spirit and scope of the invention.

The claim defining the invention are as follows:

1 An interactive on line marketing system which allows the marketing by a supplier of products and/or services to a remote participant consumer through a supplier web site established by a host provider, wherein said remote participant consumer participates in an on line game, competition or the like via said supplier web site in return for providing an identifying consumer profile, pin number or the like to the web site of said supplier of goods and/or services; wherein the supplier of goods and services directly interacts with consumers of the providers goods and/or services or via the host.

2 An interactive on line marketing system according to claim 1 wherein, when said remote participant consumer enters said identifying profile, PIN number and the like said consumer is provided with a lucky number from a data base which matches said lucky number with said identifying profile, PIN number and the like.

3 An interactive marketing system according to claim 2 wherein said lucky number is used for determining the outcome for said consumer of participation in said game, competition or the like

4 An interactive marketing system for conducting marketing of goods and/or services on line between a potentially unlimited number of remote consumer participants and an unlimited number of remote goods and/or service suppliers via a host which facilitates access between said remote participants and said remote goods and service suppliers; wherein each remote participant may gain access to said host provider and to one or more web sites associated with said goods and service suppliers, thereby gaining eligibility to play in a game, competition or the like in return for providing an identifying consumer profile, pin number or the like.

5 An interactive system according to claim 3 or 4 wherein the remote suppliers include retailers, wholesalers, hoteliers and the like.

6 An interactive internet marketing system for marketing goods and/or services of a supplier to consumers according to a consumer identifying parameter, wherein a potentially unlimited number of remote consumers are directed to a potentially unlimited number of goods and/or service suppliers via a host provider web site: wherein the host provider web site has or has linkages to a potentially unlimited number of web pages; wherein said host web site includes at least one web page for at least one goods and/or services supplier; wherein said remote goods and service suppliers provide an incentive for each said remote participants to access a web site of said at least one provider directly or via said host web site, thereby establishing a marketing link between said remote consumer and said providers.

7 An interactive system according to claim 6 wherein said identifying parameter comprises an identifying consumer profile or identifying, PIN number which is matched with a lucky number displayed on said suppliers web site.

8 An interactive internet marketing system for marketing goods and/or services of at least one supplier to remote participant consumers identified according to a consumer profile or PIN number; wherein a potentially unlimited number of said remote participant consumers are directed to a web site of a potentially unlimited number of goods and/or service suppliers; wherein, the system further comprises a host web site allowing access to a potentially unlimited number of web pages by said at least one remote participant consumer who connects to said web site; wherein said remote goods and service suppliers provide an incentive for each said remote participants to access a web page of said at least one supplier; wherein said remote participants gain entry to the marketing system by one or more events, selected from, receiving a complimentary token, draw card or the like direct from the premises of the goods and/or services provider, receiving a complimentary draw card from the goods and/or services provider via direct mail out to said remote participant.

9 An interactive marketing system according to claim 8 wherein, the draw card includes one or more of, a token, an answer to a question, or a PIN number.

10 An interactive system according to claim 9 wherein, the token or card may be given away at the premises of the goods and/or services provider or may be mailed to prospective customers.

11 An interactive system according to claim 10 wherein the PIN number will be a lucky number unique to each card.

12 An interactive on line marketing method in which a potentially unlimited number of remote participants are directed directly or via a host web site to a web site of a potentially unlimited number of goods and/or service providers: wherein the method comprises the steps of;
a) establishing a host web site;
b) allowing at least one remote participant consumer to connect to said host web site;
c) providing at said web site links to at least one web page for at least one goods and/or services provider;
d) inviting each said consumers to provide an identifying parameter such as a PIN number consumer profile or the like;
e) allowing each consumer to participate in an on line game, competition or the like via said supplier web site in return for providing an identifying consumer profile, pin number or the like to the web site of said supplier of goods and/or services.

13 An interactive on line marketing system according to claim 12 comprising the further steps before each consumer participates in said game competition or the like of,
a) providing an incentive for each said remote participants to access a web site of said at least one supplier via said host web site; and
b) initially engaging a remote participant by providing a complimentary draw card, token or the like from which the remote participant obtains a key to enter the marketing system.

14 A method according to claim 13 comprising the additional step of direct mailing said remote participants or handing to remote participants a token, number, card or the like having a unique identifier for each remote participant enabling each said remote participant to participate in said competition via a web site of each goods and/or services provider.

15. A method according to claim 14 wherein a participant initially interacts with said at least one supplier by the completion of a number of questions which might relate to the remote participants consumer profile whereupon the participant will then be taken to a question and answer submit page in which the remote participant will answer a number of questions which will establish a profile in a host/provider website data base about the remote participant.

16 A method according to claim 15; wherein, in return for the remote participant submitting to questions about the participant's profile, the host/provider web site owner will allow the remote participant to participate in the system and wherein the host/provider at the same time develops a data base based on a profile for each one of the remote participants.

17 A method for providing interactive on line marketing system in which a potentially unlimited number of remote participants are directed to a potentially unlimited number of goods and/or service suppliers via a host web site: wherein the method comprises the steps of;
a) establishing a host/provider web site having or having links to a potentially unlimited number of web pages for a potentially unlimited number of goods and services suppliers;
b) allowing at least one remote participant consumer to connect to said host web site;
c) providing an incentive for each said remote participants to access a web site of said at least one supplier either direct or via said host web site;
d) initially engaging a remote participant by providing at the premises of a goods and services supplier, via mail, via telecommunications or via the internet to said remote participant, a complimentary draw card, token or the like from which the remote participant obtains a key to enter the marketing system; wherein said key may be selected from a PIN number which will be unique to each remote participant, a phrase, word or the like;
e) allowing each said remote participant to enter a web site of a participating goods and/or services supplier;
f) inviting said remote participant to submit to a questionnaire to establish a profile of said participant;
g) inviting said remote participant to visit the goods and services suppliers premises to gain promotional advantages.

18 A method according to claim 17 wherein when said PIN number for a remote participant is entered, questions about the participant may be answered by default.

19 A method according to claim 18 wherein participants answers to questions at the web site allows the goods and/or services supplier to compile a consumer profile for the remote participant for future marketing opportunities.

20 A method according to claim 19 wherein an incentive for each said remote participant to engage a specific web page of said host is a reward such as a voucher or gift of services or goods provided by the goods or services supplier.

21 A method according to claim 20 comprising the further step of allowing the remote participant consumers to communicate with one or more other remote suppliers of goods and/or services wherein the suppliers include producers, distributors, wholesalers, retailers and the like; and wherein there is provided a host/provider web site through which said remote participants may communicate to access a web site of said suppliers.

22 A method of interactive on line marketing in which a potentially unlimited number of remote consumer participants are directed to a potentially unlimited number of goods and/or service suppliers via a host/provider web site: wherein the method comprises the steps of
a) establishing a universal host web site having at least a home page;
b) providing selected remote consumer participants with an incentive to visit said host/provider web site;
c) providing each said participants with an identifying parameter/s unique to each participant;
d) providing at said web site, means to enable each said participant to enter said unique identifying parameter/s thereby gaining access to a web site of one or more said suppliers;
e) inviting said participant to complete a particulars page or assigning a completion default status to each said participant;
f) allowing participant access to a web site of said supplier whereupon said participant is provided with an incentive or reward to participate in viewing/consuming the suppliers products or to enter a draw for a prize or reward by viewing said suppliers products.

23 A method according to claim 22 wherein the incentive to contact said host web site may include, a complimentary draw card, mail out, telephone promotion, internet promotion.

24 A method according to claim 23 wherein participants interact with said suppliers' web sites in return for a potential reward for participation in a game, quiz, competition or the like.

25 A method according to claim 24 comprising the further steps of;
a) after obtaining said identifying parameter/s from said participants, compiling a data base of unique consumer identifying parameters;
b) assigning a lucky number to each participant's identifying parameter and entering said identifying parameters and said lucky numbers into a data base;
c) down loading said data base into a predesignated web site;
d) once said data base in compiled, randomly selecting said one or more remote participants and providing each said participant with at least one identifying parameter and lucky number; and
e) providing each said participant with an address of a designated website.

26 A method according to claim 25 wherein said data base is loaded into the suppliers web site.

27 A method according to claim 26 wherein identifying parameters may include PIN numbers, and/or or participant profiles.

28 A method according to claim 27 wherein, when said PIN number is entered in a home page of said supplier web site, triggering access to at least, one other web page disclosing a lucky number associated with said PIN number.

29 A method according to claim 22 wherein a data base of PIN numbers and lucky numbers associated with each said PIN numbers is created prior to inviting participation in said system by each said remote consumer participants.

30 A method according to claim 29 wherein said data base is loaded into a predesignated provider website.
